(19) United States
(12) Patent Application Publication
(10) Pub. No.: US 2026/0319215 A1
(43) Pub. Date: Oct. 15, 2026

(54) OPTICS ELEMENT FOR INSERTION INTO AN OPTICAL APPARATUS, OPTICAL APPARATUS, METHOD FOR PRODUCING AN OPTICS ELEMENT, AND METHOD FOR PRODUCING AN OPTICAL APPARATUS

(71) Applicant: TRIOPTICS GmbH, Wedel (DE)

(72) Inventor: Christian BUSS, Wedel (DE)

(73) Assignee: TRIOPTICS GmbH, Wedel (DE)

(21) Appl. No.: 19/687,780

(22) Filed: May 26, 2026

Related U.S. Application Data
(63) Continuation of application No. PCT/EP2024/083205, filed on Nov. 22, 2024.

(30) Foreign Application Priority Data
Nov. 24, 2023 (DE) 10 2023 132 805.0

(51) Int. Cl. G02B 7/02

(52) U.S. Cl. CPC G02B 7/023

(57) ABSTRACT

An optics element for insertion into an optical apparatus, the optics element comprising an optical element that has at least one optical property that has a deviation from a default value. With regard to the insertion of the optics element into the optical apparatus, the deviation causes adjustment of the optics element relative to the optical apparatus. The optics element also comprises at least one adjustment element that is joined to the optical element by a generative manufacturing process. The at least one adjustment element is produced on the basis of the deviation. The at least one adjustment element is designed to function as a passive adjustment structure for compensating for the deviation during insertion of the optics element into a holding device of the optical apparatus.

This nonprovisional application is a continuation of International Application No. PCT/EP2024/083205, which was filed on Nov. 22, 2024, and which claims priority to German Patent Application No. 10 2023 132 805.0, which was filed in Germany on Nov. 24, 2023, and which are both herein incorporated by reference.

### BACKGROUND OF THE INVENTION

### Field of the Invention

The invention is based on optics element for insertion into an optical apparatus, an improved optical apparatus, an improved method for fabricating an optics element and an improved method for fabricating an optical apparatus.

### Description of the Background Art

Optical elements usually require an alignment for use in optical apparatuses in order that the overall system can achieve the predefined specifications. Conventionally, it is possible to use material-removing methods such as turning or milling for the alignment processing or for the alignment turning. Microtechnical methods such as laser ablation are also conceivable, for example as described in DE 10 2018 106 468 A1, which corresponds to US 2021/003805.

Furthermore, DE 10 2016 101 928 A1 describes a method for manufacturing an optoelectronic sensor formed of a lens element and a detector. In particular, the method consists in bringing the two components into a desired position and orientation relative to each other in the first step, with said components being temporarily held mechanically. In the second step, material is applied around the components by means of additive manufacturing, 3D printing, such that these components remain permanently in the pre-aligned position.

### SUMMARY OF THE INVENTION

It is therefore an object of the present invention to provide an improved optics element for insertion into an optical apparatus, an improved optical apparatus, an improved method for fabricating an optics element and an improved method for fabricating an optical apparatus.

The described approach enables a simple yet very exact passive alignment of an optical element within an optical apparatus. To this end, in particular, dimensionally accurate reference surfaces or alignment elements can be fabricated on the optical element, by additive manufacturing, in order to be used for the passive alignment.

An optics element for insertion into an optical apparatus can comprise the following features: an optical element having at least one optical property with a deviation from a target value, the deviation causing an alignment of the optics element relative to the optical apparatus in the context of the insertion of the optics element into the optical apparatus; and at least one alignment element attached to the optical element by an additive manufacturing process, with the at least one alignment element being produced on the basis of the deviation and with the at least one alignment element being formed so as to function as a passive alignment structure for compensating for the deviation when the optics element is inserted into a holding device of the optical apparatus.

An optical apparatus can be understood to mean an optical system. The optical apparatus can be designed to generate, guide, deflect and in addition to that, or as an alternative, modify a light beam. The optical element can be designed to generate, guide, deflect and in addition to that, or as an alternative, modify a light beam. An additive manufacturing process may also be referred to as a generative manufacturing process. With regard to the insertion of the optics element into the optical apparatus, the deviation can cause an alignment, in particular of the optical element with respect to the optical apparatus.

In this context, the at least one optical property can be a position and orientation of the optical axis, a centration error, a center thickness or a modulation transfer function. The position and orientation of the optical axis can be defined with respect to an outer boundary or outer surfaces of the optical element.

Furthermore, the optical element can be a passive or an active optical element. In particular, the optical element can be a lens, an objective or a laser diode. The optical element can be rotationally symmetric, have a different type of symmetry or be asymmetric. Thus, the concept described herein may be applied in a very broad range of fields.

An optical apparatus can comprise the following features: at least one example of an optics element; and a holding device for holding the at least one optics element, with the at least one optics element being aligned by passive alignment by means of the at least one alignment element when said optics element is in a state held by the holding device.

The use of at least one optics element, as presented herein, enables a passive alignment of the optical apparatus, which can be carried out in a simple and precise manner, in particular during final assembly.

The optical apparatus can be an objective or a camera. This results in a broad and diverse field of application of the concept mentioned herein.

The holding device may also be a mount or a tube. The holding device may be designed to affix at least one example or piece of an example of the optics element mentioned herein.

A method for fabricating an optics element as mentioned herein comprises the following steps: determining the deviation of the at least one optical property of the optical element from the target value; and producing the at least one alignment element on the basis of the deviation by means of an additive manufacturing process on the optical element.

An example of an optics element as mentioned herein can be advantageously produced by carrying out the method. Advantageously, both the determination step and the production step can be carried out in an automated manner.

In the production step, the at least one alignment element can be produced on the optical element with dimensional accuracy in relation to the holding device of the optical apparatus. For this purpose, a direct, dimensionally accurate application of material can thus be carried out.

The method may include a step of generating a dimensionally accurate replication template of the holding device. The at least one alignment element can be produced on the optical element relative to the replication template in the production step. In this case, the method may include a step of removing the optics element from the replication template. The replication template may also be referred to as a master. Thus, a master of the structure designed to affix or hold the optical element in the optical apparatus is deliberately replicated.

A method for fabricating an optical apparatus as mentioned herein can comprise the following step: arranging the at least one optics element in the holding device, with a passive alignment of the at least one optics element being performed by means of the at least one alignment element.

An an optical apparatus as mentioned herein can be advantageously produced by carrying out the method. In this case, the arrangement step can advantageously be carried out in an automated manner.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of an example of an optics element;

FIG. 2 shows a schematic illustration of an example of an optical apparatus;

FIG. 3 shows a schematic illustration of an example of an optics element in a replication template;

FIG. 4 shows a schematic illustration of an example of an optics element in a replication template;

FIG. 5 shows a schematic illustration of an example of an optics element;

FIG. 6 shows a schematic illustration of an example of an optical apparatus;

FIG. 7 shows a flow chart of an example of a method for fabricating an optics element; and

FIG. 8 shows a flow chart of an example of a method for fabricating an optical apparatus.

### DETAILED DESCRIPTION

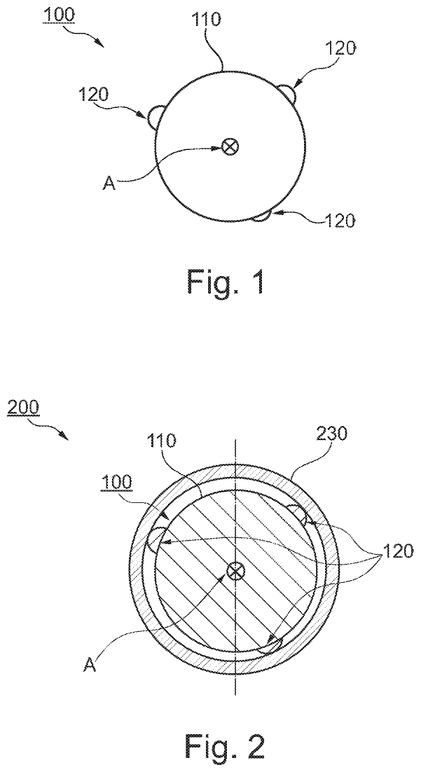

FIG. 1 shows a schematic illustration of an example of an optics element 100. The optics element 100 is provided for insertion into or use in an optical apparatus, as described in even more detail with reference to the following figures.

The optics element 100 comprises an optical element 110, for example a lens element in this case, and at least one alignment element 120, three alignment elements 120 in this case merely by way of example, which are additively attached to the optical element 110.

The optical element 110 has at least one optical property with a deviation from a target value. The optical property is such that the deviation causes an alignment of the optics element, more precisely of the optical element 110, relative to the optical apparatus in the context of the insertion of the optics element 100 into the optical apparatus. The position and orientation of the optical axis A is shown here as an example of such an optical property.

The at least one alignment element 120 is attached to the optical element 110 by a generative or additive manufacturing process. In this case, the at least one alignment element 120 is produced on the basis of the above-mentioned deviation in the optical property. The at least one alignment element 120 is formed so as to function as a passive alignment structure for compensating for the deviation when the optics element is inserted into a holding device of the optical apparatus.

In addition to the position and orientation of the optical axis A, a centration error, a center thickness or a modulation transfer function are also examples of the at least one optical property of the optical element 110. The optical element 110 is a passive optical element according to an example. According to an example, the optical element 110 is an active optical element. In particular, the optical element 110 is embodied as a lens, as an objective or as a laser diode.

FIG. 2 shows a schematic illustration of an example of an optical apparatus 200. The optical apparatus 200 comprises at least one optics element 100 and a holding device 230. The optics element 100 corresponds to or resembles the optics element from FIG. 1. Hence, the optics element 100 in this case also comprises the optical element 110, for example a lens element in this case, and the at least one alignment element 120, three alignment elements 120 in this case merely by way of example, which are additively attached to the optical element 110. The holding device 230 is designed to hold or affix the at least one optics element 100. In this case, the at least one optics element 100 is aligned by passive alignment by means of the at least one alignment element 120 when said optics element is in a state held by the holding device 230.

For example, the optical apparatus 200 is an objective or a camera. The holding device 230 is embodied as a mount or as a tube.

In other words, FIG. 1 and FIG. 2 show direct application of reference surfaces, as is also envisaged in an example of a method that is explained in more detail below. Here, FIG. 1 shows application of dimensionally accurate reference points or reference surfaces, or the optical element 110 with alignment elements 120 applied with dimensional accuracy. FIG. 2 shows insertion of the optics element 100 into a mounting or a tube, or the optics element 100 inserted into the holding device 230. In this case, the at least one alignment element 120 is produced on the optical element 110 with dimensional accuracy in relation to the holding device 230 of the optical apparatus 200.

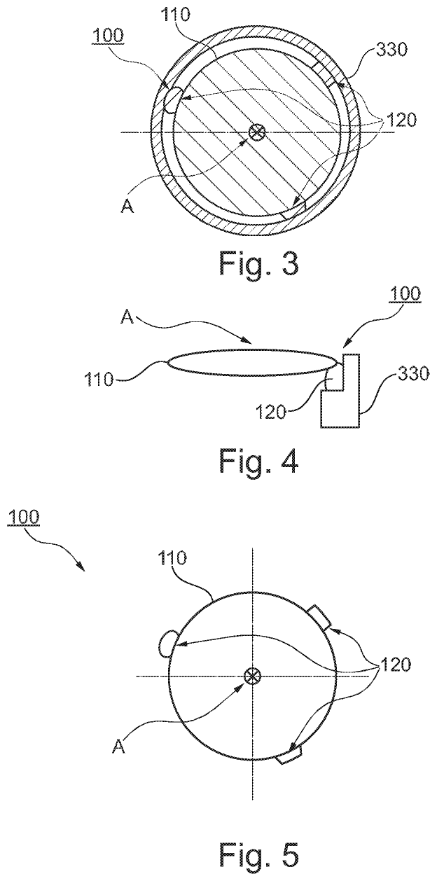

FIG. 3 shows a schematic illustration of an example of an optics element 100 in a replication template 330. In this case, the optics element 100 corresponds to or resembles the optics element from one of the above-described figures, with the exception of the fact that the additively or generatively manufactured alignment elements 120 of the optical element 100 are produced by replication in FIG. 3.

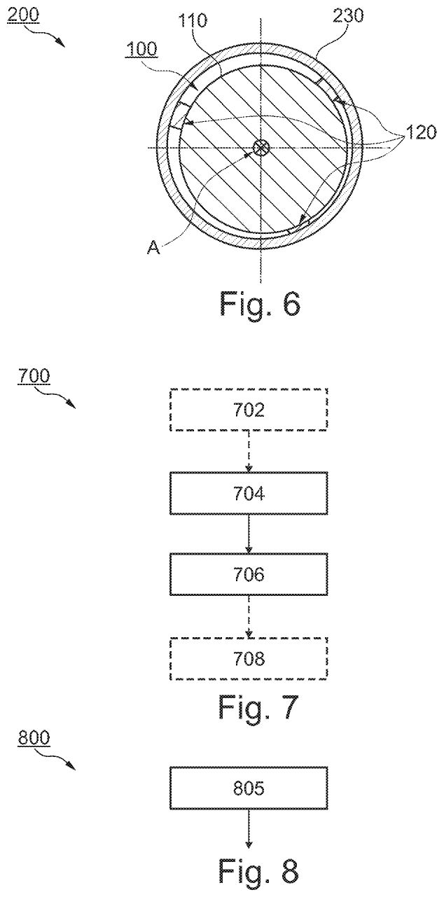

For this purpose, the optical element 110, here also embodied for example as a lens element, is arranged in the replication template 330, which can also be referred to as a replication tool or molding master. The replication template 330 is generated with dimensional accuracy with respect to the holding device of the optical apparatus, for example with respect to the holding device from FIG. 2 and/or FIG. 6. The alignment elements 120 are produced generatively or additively on the optical element 110 relative to the replication template 330 with dimensional accuracy.

In this case, FIG. 3 shows the optics element 100 and the replication template 330 in a top view. It is evident here that a lateral position or orientation of the optical element 110 relative to the replication template 330 is set by the alignment elements 120.

FIG. 4 shows a schematic illustration of an example of an optics element 100 in a replication template 330. In this case, the optics element 100 and the replication template 330 correspond to those from FIG. 3, with the optics element 100 and the replication template 330 being shown in a cross-sectional illustration in the illustration of FIG. 4. It is evident here that a vertical or axial position or orientation of the optical element 110 relative to the replication template 330 is set by the alignment elements 120.

FIG. 5 shows a schematic illustration of an example of an optics element 100. The optics element 100 corresponds to the optics element from FIG. 3 and/or FIG. 4. In this case, the optics element 100 is removed from the replication template shown in FIG. 3 and FIG. 4. The alignment elements 120 or reference surfaces for passive alignment are thus additively attached and subsequently molded.

FIG. 6 shows a schematic illustration of an example of an optical apparatus 200. In this case, the optical apparatus 200 corresponds to the optical apparatus from FIG. 2, with the exception that the optics element 100 has been fabricated in the manner illustrated in FIGS. 3 to 5. In other words, the optics element 100 in FIG. 6 comprises the alignment elements 120 which are generatively or additively attached and formed or molded as explained in FIGS. 3 to 5. The optics element 100 is likewise inserted into a holding device 230. For example, the holding device 230 is the mount of a lens, which is the optical apparatus 200, for example.

FIG. 7 shows a flow chart of an example of a method 700 for fabricating an optics element. The fabrication method 700 can be carried out in order to fabricate the optics element from one of the figures described above or a similar optics element. The fabrication method 700 comprises a determination step 704 and a production step 706.

The deviation of the at least one optical property of the optical element from the target value is determined in the determination step 704. Subsequently, the at least one alignment element is produced on the optical element by an additive manufacturing process in the production step 706 on the basis of the determined deviation.

In the production step 706 of an example, the at least one alignment element is produced on the optical element with dimensional accuracy in relation to the holding device of the optical apparatus. A procedure according to this exemplary example is illustrated in FIGS. 1 and 2.

According to another example, the production method 700 also comprises a step 702 of generating a dimensionally accurate replication template of the holding device of the optical apparatus. For example, such a replication template is shown in FIGS. 3 and 4. In that case, the at least one alignment element is produced on the optical element relative to the replication template in the production step 706. Furthermore, the production method 700 also comprises a step 708 of removing the optics element from the replication template. A procedure according to this example is illustrated in FIGS. 3 to 6.

FIG. 8 shows a flow chart of an example of a method 800 for fabricating an optical apparatus. The fabrication method 800 can be carried out in order to fabricate the optical apparatus from one of the figures described above or a similar optical apparatus. The fabrication method 800 comprises an arrangement step 805.

In the arrangement step 805, the at least one optics element is arranged in the holding device. In this case, a passive alignment of the at least one optics element is performed by means of the at least one alignment element. The passive alignment advantageously results on account of the at least one alignment element, which is attached to the optical element by an additive or generative method.

Thus, a method is presented for fabricating reference surfaces or alignment elements 120 on optical elements 110 by additive manufacturing. This can be used in the alignment processing of optics and/or in the manufacture of composite optical components and/or cameras.

According to examples, restrictions which are frequently associated with conventionally customary methods of alignment processing, for example, can be advantageously circumvented. The fabrication of reference surfaces on mounts by means of machining, the so-called alignment turning, is usually used to assemble lenses. However, not every material can be machined precisely; there are also applications in which the optics cannot be clamped rigidly enough to enable precise machining, especially in micro-optics. Not least, if the optical material itself cannot be machined, the optics should be mounted in a mount which is suitable for machining. This can be disadvantageous in applications with limited installation space. Thus, some cases require the production of reference surfaces without the optical element being able to be inserted into a mount which can then be machined. This can be achieved by way of examples, wherein the optical element 110 can be arranged in an optical apparatus 200 by the alignment elements 120 by means of a passive alignment.

Conventionally, further requirements may arise, in particular due to the need for assembly in the clean room. For this reason, for example, an active alignment and assembly of lens elements in an objective has been developed. In this case, the lens element is brought into the target position by a hexapod and affixed there by means of UV-curing adhesive. However, this procedure can become economically unviable in particular if the application does not permit a UV adhesive, as is the case in many military applications, because the hexapod is intended to hold the lens element in position until the adhesive has cured. Should it be possible to position the lens element in the mount by way of reference surfaces, then the adhesive bond to the mounting would no longer be dependent on active alignment and would become independent of the type of adhesive. This can be achieved according to the examples herein.

Consequently, the alignment of optics can dispense with machining methods, such as turning, milling and the like, which require a mount that can be processed. Other known methods, such as laser ablation, also remove material from the optical element, and this material should be removed from the processing zone so that the optical element is not contaminated. The known methods can be complicated and possibly not compatible with certain manufacturing methods, for example due to lack of cleanroom compatibility.

In particular, according to examples, the disadvantages frequently associated with the alignment turning can be avoided, since the optics need not be grasped if the optics are not machinable in general, and moreover clean-room compatibility can be achieved. Furthermore, in accordance with examples, the disadvantages frequently associated with active alignment and assembly can be avoided, since a restriction of use for a certain spectrum of adhesives can be dispensed with. Consequently, many of the aforementioned process-related disadvantages of conventional methods can be avoided by way of the additive or generative manufacture of the alignment elements 120 on the optical element 110 before the insertion into the holding device 230 of the optical apparatus 200.

According to examples, reference surfaces or alignment elements 120 are generated on these optical elements 110 by additive manufacturing, in particular for the assembly of passive and active optical elements 110. For this purpose, the optical properties of an optical element 110, in particular the centration error or the position and orientation of the optical axis A but also the center thickness and further properties, are measured and then material for the alignment elements 120 is added in relation to these measured values such that the added material can be used as a reference point for a passive alignment.

Consequently, according to examples, in the context of orienting optical elements 110, in particular lens elements, by way of reference surfaces or alignment elements 120, the following advantages can be offered in particular by passive alignment: The optical element 110, for example the lens element, no longer need be grasped separately or adhesively bonded into a mount. The technique of attaching reference surfaces or alignment elements 120 is compatible with clean rooms. The technique of attaching reference surfaces or alignment elements 120 is not tied to rotationally symmetric lens elements or optical elements 110, unlike alignment turning.

In this case, according to examples, two different procedures are conceivable: Firstly, the direct, dimensionally accurate application of material; secondly, the targeted replication of a master. For example, both are represented by the lateral orientation of the optical axis A of a lens element as an optical element 110 with respect to a mount or a tube as a holding device 230. However, the application is not limited thereto and can also be applied to other references.

The position and orientation of the optical axis A is measured for the purpose of directly attaching reference surfaces or alignment elements 120. Subsequently, material is applied to the boundary or else only to discrete locations on the optical element 110 such that the boundary or the discrete points are at the same distance from the optical axis A. If the lens element or the optical element 110 with the references or alignment elements 120 is now joined, the optical axis A is oriented with respect to the mount or holding device 230 by passive alignment. Depending on the tolerance requirement, an active alignment is no longer necessary.

The replication or production of the reference surfaces or alignment elements 120 by replication requires the replication template 330 or a master having an inner diameter and optionally bearing surfaces which correspond to the later inner diameter on the lens or the holding device 230 of the optical apparatus 200. In order that the lens element or the optical element 110 cannot stick to the master or the replication template 330, the master is created from a material such that the applied material does not adhere or can at least be easily detached again, for example by pressing it out. Then, the optical axis A is measured, and the lens element or the optical element 110 is oriented relative to this master or the replication template 330 such that the optical axis A is centered relative to the master. The lens element is positioned laterally and axially, and the material for fabricating the reference surfaces or alignment elements 120 is applied. Subsequently, the lens element is separated from the master and now has reference surfaces or alignment elements 120 which are oriented toward the optical axis A.

It is furthermore also conceivable for reference structures or alignment elements 120 to be attached to complete lenses as optical elements 110 in accordance with an MTF (modulation transfer function) or wavefront measurement. Thus, an existing process can be broken down into the measurement and orientation of the camera by applying references and adhesively bonding the camera to the sensor chip. This may be useful under certain circumstances if the camera chip cannot be contacted.

In the context of the alignment of laser diodes as optical elements 110, too, the application of reference surfaces or alignment elements 120 can serve to orient the laser beam in order to compensate for manufacturing tolerances in the fabrication of laser diodes.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An optics element for insertion into an optical apparatus, the optics element comprising:
an optical element having at least one optical property with a deviation from a target value, the deviation causing an alignment of the optics element relative to the optical apparatus in a context of the insertion of the optics element into the optical apparatus; and
at least one alignment element attached to the optical element by an additive manufacturing process, with the at least one alignment element being produced on the basis of the deviation and with the at least one alignment element being formed so as to function as a passive alignment structure for compensating for the deviation when the optics element is inserted into a holding device of the optical apparatus.

2. The optics element as claimed in claim 1, wherein the at least one optical property is a position and orientation of the optical axis, a centration error, a center thickness, or a modulation transfer function.

3. The optics element as claimed in claim 1, wherein the optical element is a passive or an active optical element, a lens, an objective, or a laser diode.

4. An optical apparatus comprising:
the at least one optics element as claimed in claim 1; and
a holding device to hold the at least one optics element,
wherein the at least one optics element is aligned by passive alignment via the at least one alignment element when the optics element is in a state held by the holding device.

5. The optical apparatus as claimed in claim 4, wherein the optical apparatus is an objective or a camera.

6. The optical apparatus as claimed in claim 4, wherein the holding device is a mount or a tube.

7. A method for fabricating the optics element as claimed in claim 1, the method comprising:
determining a deviation of the at least one optical property of the optical element from a target value; and
producing the at least one alignment element on the basis of the deviation via an additive manufacturing process on the optical element.

8. The method as claimed in claim 7, wherein, in the production step, the at least one alignment element is produced on the optical element with dimensional accuracy in relation to the holding device of the optical apparatus.

9. The method as claimed in claim 7, further comprising:
generating a dimensionally accurate replication template of the holding device with the at least one alignment element being produced on the optical element relative to the replication template in the production step; and
removing the optics element from the replication template.

10. A method for fabricating an optical apparatus, the method comprising:
providing the optical apparatus as claimed in claim 4; and
arranging the at least one optics element in the holding device, with a passive alignment of the at least one optics element being performed via the at least one alignment element.
